(19) United States
(12) Patent Application Publication
(10) Pub. No.: US 2024/0232572 A1
(43) Pub. Date: Jul. 11, 2024

(54) NEURAL NETWORKS WITH ADAPTIVE STANDARDIZATION AND RESCALING

(71) Applicant: GOOGLE LLC, Mountain View, CA (US)

(72) Inventors: Qifei WANG; Junjie KE; Feng YANG; Boqing GONG; Xinjie FAN

(21) Appl. No.: 18/289,100

(22) PCT Filed: May 26, 2022
(86) PCT No.: PCT/US2022/072576

§ 371 Date: Oct. 31, 2023

Related U.S. Application Data
(60) Provisional application No. 63/193,501, filed on May 26, 2021.

(51) Int. Cl. G06N 3/04; G06N 3/094

(52) U.S. Cl. CPC G06N 3/04; G06N 3/094

(57) ABSTRACT

Methods, systems, and apparatus, including computer programs encoded on a computer storage medium, for processing a network input using a neural network to generate a network output. The neural network includes a normalization block that is between a first neural network layer and a second neural network layer in the neural network. Processing the network input using the neural network comprises: receiving a first layer output from the first neural network layer; processing data derived from the first layer output using standardization neural network layers of the normalization block to generate one or more adaptive standardization values; standardizing the first layer output using the adaptive standardization values to generate a standardized first layer output; generating a normalization block output from the standardized first layer output; and providing the normalization block output as an input to the second neural network layer.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a neural network system implemented as computer programs on one or more computers in one or more locations that is configured to process a network input using a neural network to generate a network output.

Throughout this specification, a “block” can refer to a group of one or more neural network layers.

Throughout this specification, neural network layers in the neural network may be designated as “first” neural network layers or “second” neural network layers. This designation is intended only as a convenient identifier for these neural network layers, and does not indicate the positions of these neural network layers in the architecture of the neural network. For instance, a neural network layer being designated as a “first” neural network layer does not necessarily indicate that the neural network layer occupies a first position in a sequence of neural network layers in the neural network architecture. Similarly, a neural network being designated as a “second” neural network layer does not necessarily indicate that the neural network layer occupies a second position in a sequence of neural network layers in the neural network architecture.

Throughout this specification, “standardizing” a collection of numerical values refers to transforming the collection of numerical values using a transformation parameterized by a set of standardization values. For instance, standardizing a collection of numerical values can include, for each numerical value in the collection of numerical values: (i) subtracting a first standardization value from the numerical value, and (ii) dividing a result of the subtraction by a second standardization value. Specific examples of generating standardization values, and using them to standardize a collection of numerical values, are described in detail below.

According to a first aspect, there is provided a method performed by one or more data processing apparatus, the method comprising: obtaining a network input; processing the network input using a neural network to generate a network output, wherein the neural network includes a normalization block that is between a first neural network layer and a second neural network layer in the neural network, wherein the normalization block comprises one or more standardization neural network layers, wherein processing the network input using the neural network comprises: receiving a first layer output from the first neural network layer; processing data derived from the first layer output using the standardization neural network layers of the normalization block to generate one or more adaptive standardization values; standardizing the first layer output using the adaptive standardization values to generate a standardized first layer output; generating a normalization block output from the standardized first layer output; and providing the normalization block output as an input to the second neural network layer.

In some implementations, the first layer output comprises a plurality of components that are indexed by a plurality of channels, the adaptive standardization values comprise a respective adaptive mean value for each channel, and generating the adaptive mean values comprises: computing, for each of the channels, a statistical mean value defining a statistical mean of the components of the first layer output in the channel; and processing the statistical mean values using one or more of the standardization neural network layers to generate the adaptive mean values.

In some implementations, processing the statistical mean values using one or more of the standardization neural network layers to generate the adaptive mean values comprises: processing the statistical mean values using a first standardization neural network layer to generate a lower-dimensional projected representation of the statistical mean values; processing the projected representation of the statistical mean values using an activation function; and processing a result of applying the activation function to the projected representation of the statistical mean values using a second standardization neural network layer to generate the adaptive mean values.

In some implementations, the method further comprises: updating the adaptive mean value for each channel to be a weighted average of: (i) the adaptive mean value for the channel, and (ii) the statistical mean value for the channel.

In some implementations, for each channel, the weighted average of: (i) the adaptive mean value for the channel, and (ii) the statistical mean value for the channel, is computed using a learned weighting factor.

In some implementations, the adaptive standardization values further comprise a respective adaptive standard deviation value for each channel, and generating the adaptive standard deviation values comprises: computing, for each of the channels, a respective statistical standard deviation value defining a statistical standard deviation of the components of the first layer output in the channel; and processing the statistical standard deviation values using one or more of the standardization neural network layers to generate the adaptive standard deviation values.

In some implementations, processing the statistical standard deviation values using one or more of the standardization neural network layers to generate the adaptive standard deviation values comprises: processing the statistical standard deviation values using a first standardization neural network layer to generate a lower-dimensional projected representation of the statistical standard deviation values; processing the projected representation of the statistical standard deviation values using an activation function; and processing a result of applying the activation function to the projected representation of the statistical standard deviation values using a second standardization neural network layer to generate the adaptive standard deviation values.

In some implementations, the method further comprises: updating the adaptive standard deviation value for each channel to be a weighted average of: (i) the adaptive standard deviation value for the channel, and (ii) the statistical standard deviation value for the channel.

In some implementations, the method further comprises: updating the adaptive standard deviation value for each channel to be a sum of: (i) the adaptive standard deviation value for the channel, and (ii) a predefined e value.

In some implementations, the adaptive standardization values comprise a respective adaptive mean value and a respective adaptive standard deviation value for each of the channels in the first layer output, and standardizing the first layer output using the adaptive standardization values comprises: standardizing each component of the first layer output using the adaptive mean value and the adaptive standard deviation value for the channel corresponding to the component.

In some implementations, standardizing each component of the first layer output using the adaptive mean value and the adaptive standard deviation value for the channel corresponding to the component comprises, for each component: subtracting, from the component, the adaptive mean value for the channel corresponding to the component; and dividing a result of the subtraction by the adaptive standard deviation value for the channel corresponding to the component.

In some implementations, generating a normalization block output from the standardized first layer output comprises: processing data derived from the first layer output using one or more rescaling neural network layers of the normalization block to generate one or more adaptive rescaling values; and generating the normalization block output by rescaling the standardized first layer output using the one or more adaptive rescaling values.

In some implementations, the first layer output comprises a plurality of components that are indexed by a plurality of channels, the adaptive rescaling values comprise a respective additive rescaling value and a respective multiplicative rescaling value for each channel, and generating the normalization block output comprises, for each component of the standardized first layer output; multiplying the component by the multiplicative rescaling value for the channel corresponding to the component; and adding the additive rescaling value for the channel corresponding to the component to a result of the multiplication.

In some implementations, generating the additive rescaling values comprises: computing, for each of the channels, a respective statistical mean value defining a statistical mean of the components of the first layer output in the channel; and processing the statistical mean values using one or more of the rescaling neural network layers to generate the additive rescaling values.

In some implementations, the method further comprises: updating each additive rescaling value by adding a learned bias term to the additive rescaling value.

In some implementations, generating the multiplicative rescaling values comprises: computing, for each of the channels, a respective statistical standard deviation value defining a statistical standard deviation of the components of the first layer output in the channel; and processing the statistical standard deviation values using one or more of the rescaling neural network layers to generate the multiplicative rescaling values.

In some implementations, the method further comprises: updating each multiplicative rescaling value by adding a learned bias term to the multiplicative rescaling value.

In some implementations, the neural network is trained using adversarial domain augmentation.

According to another aspect, there is provided a system comprising: one or more computers; and one or more storage devices communicatively coupled to the one or more computers, wherein the one or more storage devices store instructions that, when executed by the one or more computers, cause the one or more computers to perform operations of the methods described herein.

According to another aspect, there are provided one or more non-transitory computer storage media storing instructions that when executed by one or more computers cause the one or more computers to perform operations of the methods described herein.

Particular embodiments of the subject matter described in this specification can be implemented so as to realize one or more of the following advantages.

The neural network system described in this specification includes a normalization block that is configured to receive the output of a first neural network layer, standardize and rescale the normalization block input, and then provide the standardized and rescaled data to a second neural network layer. The normalization block dynamically generates the standardization and rescaling values used for standardizing and rescaling the normalization block input by processing data derived from the normalization block input using one or more neural network layers with trained parameter values. Thus the normalization block learns to generate standardization values, rescaling values, or both, that are adapted to each individual normalization block input.

Conventional systems use predefined standardization and rescaling values that are not adapted to individual block inputs, and that are determined during training of a neural network. Such predefined standardization and rescaling values may perform poorly when the neural network processes “out-of-distribution” network inputs, e.g., that are drawn from a different distribution than the set of network inputs used to train the neural network. In contrast, the normalization block described in this specification learns to generate standardization and rescaling values that are adapted to each individual block input and are thus effective even when the neural network processes out-of-distribution network inputs.

The adaptive standardization and rescaling performed by a normalization block as described in this specification can enable a neural network be trained to achieve an acceptable performance using less training data and over fewer training iterations than may be required to train a conventional neural network. That is, the normalization block can enable the neural network to learn more quickly from less training data. The normalization block can contribute to this effect, e.g., by adaptively compensating for changes in the distribution of network inputs that are provided to the neural network both before and after training, and for changes in the distribution neural network layer outputs generated by the neural network during training.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 shows an example architecture of a normalization block.

FIG. 3 is a flow diagram of an example process for processing a first layer output of a first neural network layer using a normalization block to generate a normalization block output.

FIG. 4 is a flow diagram of an example process for processing data derived from the first layer output using standardization neural network layers of a standardization block to generate adaptive standardization values.

FIG. 5 is a flow diagram of an example process for processing data derived from the first layer output using rescaling neural network layers of a rescaling block to generate adaptive rescaling values.

Like reference numbers and designations in the various drawings indicate like elements.

### DETAILED DESCRIPTION

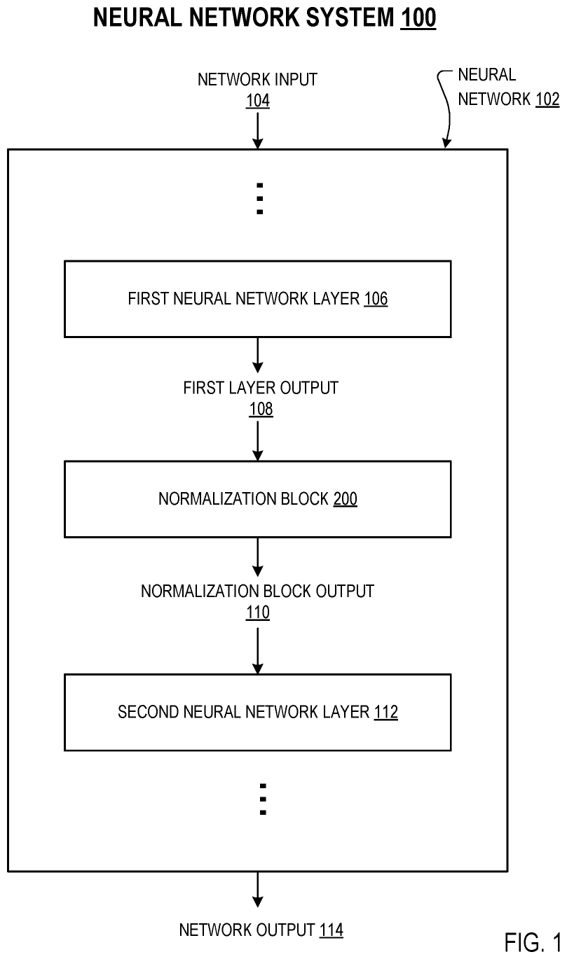

FIG. 1 shows an example neural network system 100. The neural network system 100 is an example of a system implemented as computer programs on one or more computers in one or more locations in which the systems, components, and techniques described below are implemented.

The neural network system 100 is configured to process a network input 104 using a neural network 102 to generate a corresponding network output 114.

The neural network 102 can have any appropriate neural network architecture, e.g., including any appropriate types of neural network layers (e.g., fully-connected layers, convolutional layers, self-attention layers, recurrent layers, etc.), in any appropriate numbers (e.g., 5 layers, 10 layers, or 100 layers), and connected in any appropriate configuration (e.g., as a linear sequence of layers and blocks).

In particular, the neural network 102 includes a normalization block 200. The normalization block 200 is located between a first neural network layer 106 and a second neural network layer 112 in the architecture of the neural network 102. More specifically, the normalization block 200 is configured to receive the output of the first neural network layer 106, and to generate an output that is provided to the second neural network layer 112.

The first neural network layer 106 is configured to process a first layer input, in accordance with values of a set of first neural network layer parameters, to generate a first layer output 108. The first neural network layer 106 can be any appropriate type of neural network layer, e.g., a fully-connected layer, a convolutional layer, a self-attention layer, etc.

The neural network 102 generates the first layer input, i.e., to the first neural network layer 106, from the network input 104, i.e., to the neural network 102. In some implementations, the first neural network layer 106 is an input layer of neural network, and the network input 104 provides the first layer input. In other implementations, the first neural network layer 106 is an intermediate (hidden) layer of the neural network 102, and the neural network 102 generates the first layer input by processing the network input 104 by one or more preceding neural network layers. (A “preceding” neural network layer can refer to a neural network layer that precedes the first neural network layer 106 in an ordering of the neural network layers of the neural network 102). Put another way, the first neural network layer 106 can be, e.g., an input layer of the neural network 102, or an intermediate layer of the neural network 102.

The first layer output 108 can be represented as an ordered collection of numerical values, where each numerical value may be referred to for convenience as a “component” of the first layer output 108. The components of the first layer output 108 can be indexed, at least in part, by a set of “channel” indices. For instance, the first layer output 108 can be represented by an array of numerical values with dimensionality H×W×C, i.e., where {1, . . . , H} are the “height” indices (with H≥1), {1, . . . , W} are the “width” indices (with W>1), and {1, . . . , C} are the “channel” indices (with C≥1).

The normalization block 200 is configured to process the first layer output 108, in accordance with values of a set of normalization block parameters, to generate a normalization block output 110. In particular, the normalization block 200 can generate the normalization block output 110 by standardizing the first layer output 108, rescaling the first layer output 108, or both. That is, the normalization block output 110 can be a standardized and rescaled version of the first layer output 108, e.g., such that the normalization block output 110 has the same dimensionality as the first layer output 108.

The normalization block 200 can standardize the first layer output 108 using a set of adaptive standardization values. The normalization block 200 can generate the adaptive standardization values by processing data derived from the first layer output 108 (e.g., the first layer output 108 itself, or statistical features of the first layer output 108, or both) using one or more neural network layers of the normalization block 200.

The normalization block 200 can rescale the standardized first layer output 108 using a set of adaptive rescaling values. The normalization block 200 can generate the adaptive rescaling values by processing data derived from the first layer output 108 (e.g., the first layer output 108 itself, or statistical features of the first layer output 108, or both) using one or more neural network layers of normalization block 200.

The second neural network layer 112 is configured to process the normalization block output 110, in accordance with values of a set of second neural network layer parameters, to generate a second layer output. The second neural network layer 112 can be any appropriate type of neural network layer, e.g., a fully-connected layer, a convolutional layer, a self-attention layer, etc. In some implementations, the second neural network layer 112 is an output layer of the neural network 102, and the second layer output provides the network output 114. In other implementations, the second neural network layer 112 is an intermediate (hidden) layer of the neural network 102, and the neural network 102 generates the network output 114 by processing the second layer output by one or more subsequent neural network layers. (A “subsequent” neural network layer can refer to a neural network layer that follows the second neural network layer 112 in an ordering of the neural network layers of the neural network 102). Put another way, the second neural network layer 112 can be, e.g., an intermediate layer of the neural network 102, or an output layer of the neural network 102.

The normalization block 200 can improve the performance of the neural network 102 on machine learning tasks, e.g., by enabling the neural network 102 to generate predictions more accurately, and by reducing the amount of training data required to train the neural network 102. In particular, standardizing and rescaling intermediate outputs of the neural network can enhance the robustness of the neural network to variations in the scale and magnitude of network inputs and intermediate outputs, while maintaining the semantic information content of intermediate outputs of the neural network. Generating standardization and rescaling values using trainable neural network layer parameters (e.g., of the neural network layers of the normalization blocks) enables the neural network to learn effective standardization and rescaling strategies through training.

The neural network 102 can include multiple normalization blocks, with each normalization block being included between a respective pair of neural network layers. For instance, the neural network can optionally include a respective normalization block between each pair of intermediate (hidden) layers of the neural network 102.

The neural network 102 can be configured to perform any appropriate machine learning task. More specifically, the neural network can be configured to process any appropriate network input, e.g., an image, an audio waveform, a point cloud (e.g., generated by a lidar or radar sensor), a representation of a protein, a sequence of words (e.g., that form one or more sentences or paragraphs), a video (e.g., represented a sequence of video frames), or a combination thereof. In some examples, a sensor (e.g. an image sensor or audio sensor or the lidar and radio sensors mentioned above) may generate the network input. The neural network can be configured to generate any appropriate network output that characterizes the network input. For example, the network output can be a classification output, a regression output, a sequence output (i.e., that includes a sequence of output elements), segmentation output, an embedding, or a combination thereof.

The neural network 102 described herein is widely applicable and is not limited to one specific implementation. However, for illustrative purposes, a few example implementations are described next.

In some implementations, the neural network processes a network input that represents the pixels of an image. It may do so to generate a classification output such as a classification output that includes a respective score for each object category in a set of possible object categories (e.g., vehicle, pedestrian, bicyclist, etc.). The score for an object category can define a likelihood that the image depicts an object that belongs to the object category.

In some implementations, the neural network processes a network input that represents audio samples in an audio waveform. It may do so to perform speech recognition, i.e., to generate an output that defines a sequence of phonemes, graphemes, characters, or words corresponding to the audio waveform.

In some implementations, the neural network processes a network input that represents words in a sequence of words to perform a natural language processing task, e.g., topic classification or summarization. To perform topic classification, the neural network generates a network output that includes a respective score for each topic category in a set of possible category categories (e.g., sports, business, science, etc.). The score for a topic category can define a likelihood that the sequence of words pertains to the topic category. To perform summarization, the neural network generates a network output that includes an output sequence of words that has a shorter length than the input sequence of words and that captures important or relevant information from the input sequence of words.

In some implementations, the neural network performs a machine translation task, e.g., to process a network input that represents a sequence of text, e.g., a sequence of words, phrases, characters, or word pieces, in one language, to generate a network output that can be a translation of the sequence of text into another language, i.e., a sequence of text in the other language that is a translation of the input sequence of text. As a particular example, the task can be a multi-lingual machine translation task, where the neural network is configured to translate between multiple different source language—target language pairs. In this example, the source language text can be augmented with an identifier that indicates the target language into which the neural network should translate the source language text.

In some implementations, the neural network performs an audio processing task. For example, if the network input represents a spoken utterance, then the output generated by the neural network can be a score for each of a set of pieces of text, each score representing an estimated likelihood that the piece of text is the correct transcript for the utterance. As another example, if the network input represents a spoken utterance, the output generated by the neural network can indicate whether a particular word or phrase (“hotword”) was spoken in the utterance. As another example, if the network input represents a spoken utterance, the output generated by the neural network can identify the natural language in which the utterance was spoken.

In some implementations, the neural network performs a natural language processing or understanding task, e.g., an entailment task, a paraphrase task, a textual similarity task, a sentiment task, a sentence completion task, a grammaticality task, and so on, that operates on a network input representing text in some natural language.

In some implementations, the neural network performs a text to speech task, where the network input represents text in a natural language or features of text in a natural language and the network output is a spectrogram, a waveform, or other data defining audio of the text being spoken in the natural language.

In some implementations, the neural network performs a health prediction task, where the network input represents data derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. The electronic health data may comprise observed measurements of the patient's physiological condition such as, for example, a patient's heartbeat or another physiological parameter.

In some implementations, the neural network performs a text generation task, where the network input represents a sequence of text, and the output is another sequence of text, e.g., a completion of the input sequence of text, a response to a question posed in the input sequence, or a sequence of text that is about a topic specified by the first sequence of text. As another example, the network input can represent data other than text, e.g., an image, and the output sequence can be text that describes the data represented by the network input.

In some implementations, the neural network performs an image generation task, where the network input represents a conditioning input and the output is a sequence of intensity value inputs for the pixels of an image.

In some implementations, the neural network performs an agent control task, where the network input represents a sequence of one or more observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The disclosed techniques may comprise operating the agent to perform the task defined by the output of the neural network.

In some implementations, the neural network performs a genomics task, where the network input represents a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some implementations, the neural network performs a protein modeling task, e.g., where the network input represents a protein and the network output characterizes the protein. For example, the network output can characterize a predicted stability of the protein or a predicted structure of the protein.

In some implementations, the neural network performs a point cloud processing task, e.g., where the network input represents a point cloud (e.g., generated by a lidar or radar sensor) and the network output characterizes, e.g., a type of object represented by the point cloud.

In some implementations, the neural network performs a combination of multiple individual machine learning tasks, e.g., two or more of the machine learning tasks mentioned above. For example, the neural network can be configured to perform multiple individual natural language understanding tasks, with the network inputs processed by the neural network including an identifier for the individual natural language understanding task to be performed on network inputs.

The system can train the neural network to optimize a machine learning objective function using any appropriate machine learning training technique, e.g., a supervised learning technique or a reinforcement learning technique. Training the neural network using a supervised learning technique can include training the neural network to optimize a supervised learning objective function, e.g., a cross-entropy objective function. The supervised learning objective function can measure, for each of multiple training network inputs, an error (e.g., a cross-entropy error) between: (i) a network output generated by the neural network by processing the training network input, and (ii) a target network output corresponding to the network input. Training the neural network using a reinforcement learning objective function can include training the neural network to optimize a cumulative measure of rewards (e.g., a time discounted sum of rewards) received as a result of network outputs generated by the neural network. The reinforcement learning objective function can be, e.g., a Q learning objective function, a policy gradient objective function, or any other appropriate reinforcement learning objective function.

In some implementations, the system trains the neural network using adversarial domain augmentation techniques, e.g., where the system synthesizes “adversarial” network inputs that are designed to have an increased likelihood of being “hard” for the neural network, and then trains the neural network on the adversarial network inputs.

A network input can be referred to as being hard for the neural network if, by processing the network input, the neural network generates an incorrect network output. An incorrect network output can be a network output that differs substantially from a target network output that should be generated by the neural network by processing the network input. For example, if the neural network is configured to perform an image classification task by processing an image to classify the image as belonging to a category in a set of categories, an adversarial network input can be an image that the neural network has an increased likelihood of misclassifying.

Training the neural network using adversarial domain augmentation techniques can increase the capability of the neural network to generate accurate predictions for network inputs that are drawn from a different distribution than a set of network inputs that were used to train the neural network. For example, training the neural network using adversarial domain augmentation techniques can enable the neural network to generate accurate predictions for network inputs that differ in “style.” e.g., visual appearance, from network inputs that were used to train the neural network. Examples of adversarial domain augmentation techniques are described with reference to: R. Volpi, H. Namkoong, O. Sener, J. C. Duchi, V. Murino, and S. Savarese. “Generalizing to unseen domains via adversarial data augmentation.” In Advances in Neural Information Processing Systems, pages 5334-5344, 2018.

Normalization blocks can be particularly effective for improving the performance of the neural network 102 when the neural network 102 is trained using adversarial domain augmentation techniques. More specifically, training the neural network using adversarial domain augmentation techniques can enable the normalization blocks to learn standardization and rescaling strategies that are optimized to be robust and effective for adversarial network inputs.

During training, the system 100 trains the set of neural network parameters of the neural network 102, including the parameters of the neural network layers of the normalization blocks of the neural network. In particular, for each normalization block, the system 100 trains the parameters of the neural network layers of the normalization block that are used to generate adaptive standardization values and adaptive rescaling values.

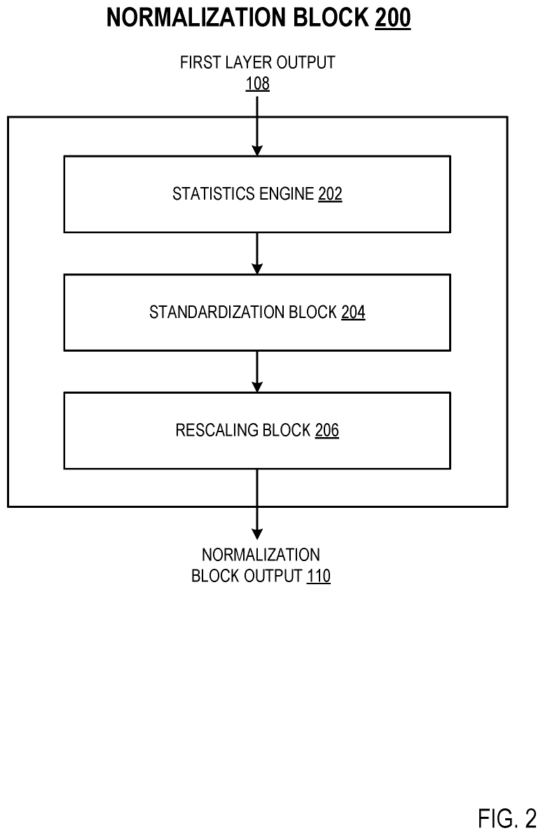

FIG. 2 shows an example architecture of a normalization block 200, e.g., that is included in the neural network 102 described with reference to FIG. 1. The normalization block 200 is configured to process a first layer output 108, e.g., of a first neural network layer of the neural network 102, to generate a normalization block output 110, e.g., that is provided to a second neural network layer of the neural network 102.

The normalization block 200 includes a statistics engine 202, a standardization block 204, and a rescaling block 206, which are each described next.

The statistics engine 202 is configured to process the first layer output 108 to generate statistical features of the first layer output 108. For example, for each channel of the first layer output, the statistics engine 202 can generate: (i) a statistical mean value, and (ii) a statistical standard deviation value. A statistical mean value for a channel of the first layer output 108 can define a statistical mean of the components of the first layer output 108 included in the channel. A statistical standard deviation value for a channel of the first layer output 108 can define a statistical standard deviation of the components of the first layer output 108 included in the channel.

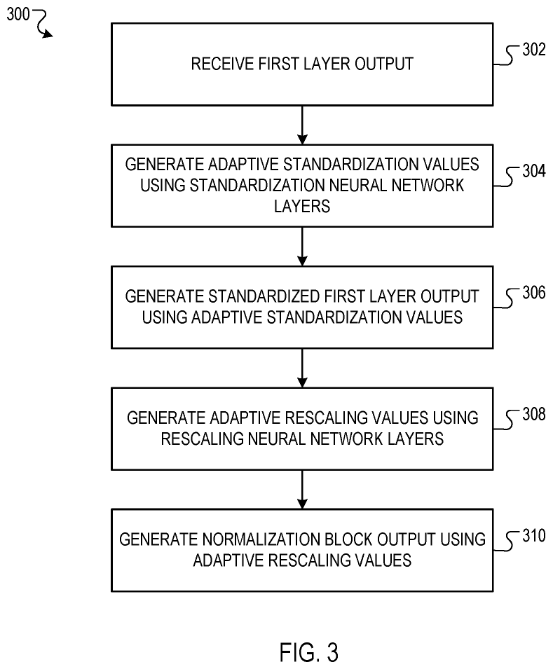

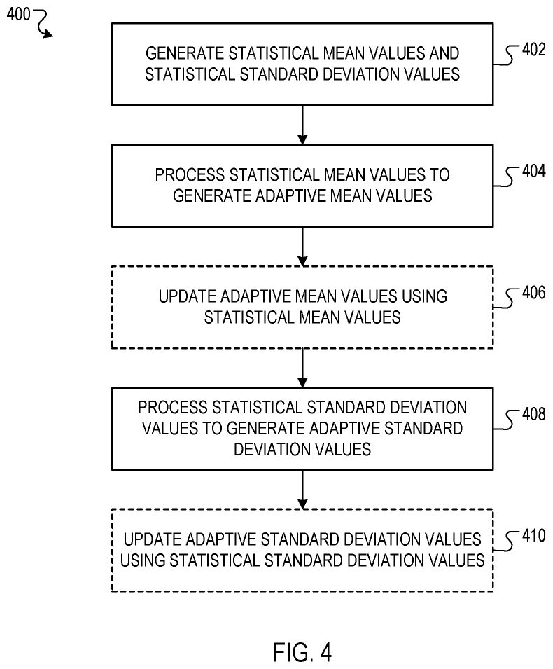

The standardization block 204 is configured to process the first layer output 108, or the statistical features of the first layer output 108, or both, using one or more neural network layers to generate adaptive standardization values. The standardization block 204 then standardizes the first layer output 108 using the adaptive standardization values to generate a standardized first layer output. Example operations that can be performed by the standardization block are described in more detail below with reference to FIG. 3 and FIG. 4.

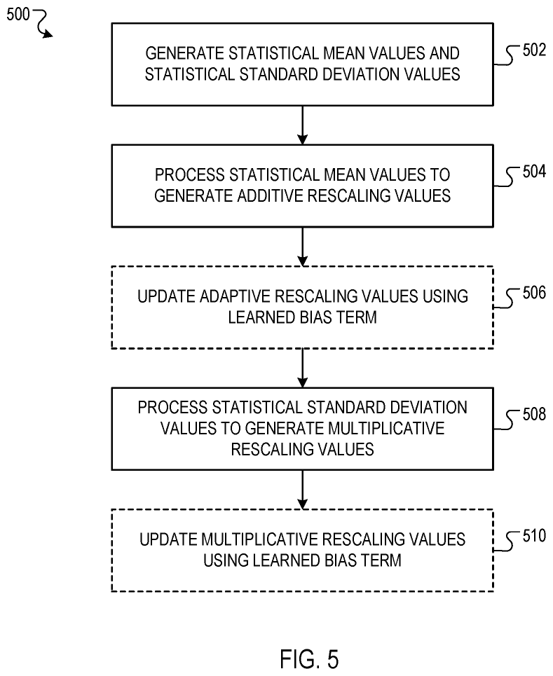

The rescaling block 206 is configured to process the first layer output 108, or the statistical features of the first layer output 108, or both, using one or more neural network layers to generate adaptive rescaling values. The rescaling block then rescales the first layer output 108 using the adaptive rescaling values to generate the normalization block output 110. Example operations that can be performed by the rescaling block are described in more detail below with reference to FIG. 3 and FIG. 5.

Processing statistical features of the first layer output 108, as an alternative to or in combination with the first layer output 108 itself, can reduce the number of parameters required to implement the neural network layers of the standardization and rescaling blocks while improving their performance.

Optionally, the normalization block 200 can be implemented with the standardization block but without the rescaling block. Similarly, the normalization block 200 can be implemented with the rescaling block 206 but without the standardization block 204.

FIG. 3 is a flow diagram of an example process 300 for processing a first layer output of a first neural network layer using a normalization block to generate a normalization block output. For convenience, the process 300 will be described as being performed by a system of one or more computers located in one or more locations. For example, a neural network system, e.g., the neural network system 100 of FIG. 1, appropriately programmed in accordance with this specification, can perform the process 300.

The system receives a first layer output from a first neural network layer (302).

The system processes data derived from the first layer output using one or more standardization neural network layers to generate one or more adaptive standardization values (304). For instance, the system can process statistical features of the first layer output using the standardization neural network layers to generate a respective adaptive mean value and a respective adaptive standard deviation value for each channel of the first layer output. An example process for generating adaptive standardization values is described in more detail below with reference to FIG. 4.

The system standardizes the first layer output using the adaptive standardization values to generate a standardized first layer output (306). More specifically, the system can standardize each component of the first layer output using the adaptive mean value and the adaptive standard deviation value for the channel corresponding to the component. For instance, the system can standardize a component x of the first layer output to generate a standardized component xₛₜₐₙ as:

$${x}_{stan} = \frac{x - {μ}_{stan}}{{σ}_{stan} + ϵ} \qquad ( 1 )$$

where μₛₜₐₙ is the adaptive mean value for the channel corresponding to component x, σₛₜₐₙ is the adaptive standard deviation value for the channel corresponding to component x, and ϵ is a small positive value that is used to improve numerical stability.

The system processes data derived from the first layer output using one or more rescaling neural network layers to generate one or more adaptive rescaling values (308). For instance, the system can process statistical features of the first layer output using the rescaling neural network layers to generate a respective additive rescaling value and a respective multiplicative rescaling value for each channel of the first layer output. An example process for generating adaptive rescaling values is described in more detail below with reference to FIG. 5.

The system generates a normalization block output by rescaling the standardized first layer output using the adaptive rescaling values (310). More specifically, the system can rescale each component of the first layer output using the additive rescaling value and the multiplicative rescaling value for the channel corresponding to the component. For instance, the system can rescale a component xₛₜₐₙ of the standardized first layer output to generate a rescaled component xₙₒᵣₘ as:

$${x}_{norm} = {x}_{stan} \cdot γ + β \qquad ( 2 )$$

where γ is the multiplicative rescaling value for the channel corresponding to component xₛₜₐₙ and β is the additive rescaling value for the channel corresponding to the component xₛₜₐₙ.

FIG. 4 is a flow diagram of an example process 400 for processing data derived from the first layer output using standardization neural network layers of a standardization block to generate adaptive standardization values. For convenience, the process 400 will be described as being performed by a system of one or more computers located in one or more locations. For example, a neural network system, e.g., the neural network system 100 of FIG. 1, appropriately programmed in accordance with this specification, can perform the process 400.

The system generates, for each channel of the first layer output: (i) a statistical mean value defining a statistical mean of the components of the first layer output in the channel, and (ii) a statistical standard deviation value defining a statistical standard deviation of the components of the first layer output in the channel (402). For example, the system can generate the statistical mean value μ_{c} for channel c as:

$${μ}_{c} = \frac{1}{H \times W} {\sum }_{i = 1}^{H} {\sum }_{j = 1}^{W} {x}_{cij} \qquad ( 3 )$$

where i indexes a height dimension of the first layer output, H is the maximum index of the height dimension, j indexes a width dimension of the first layer output, W is the maximum index of the width dimension, and x_{cij} is the component of the first layer output at channel index c, height index i, and width index j. As another example, the system can generate the statistical standard deviation value σ_{c} for channel c as:

$${σ}_{c} = \sqrt{\frac{{\sum }_{i = 1}^{H} {\sum }_{j = 1}^{W} {( {x}_{cij} - {μ}_{c} )}^{2}}{H \times W}} \qquad ( 4 )$$

where i indexes a height dimension of the first layer output, H is the maximum index of the height dimension, j indexes a width dimension of the first layer output, W is the maximum index of the width dimension, μ_{c} is the statistical mean value for channel c, and x_{cij} is the component of the first layer output at channel index c, height index i, and width index j.

The system jointly processes the set of statistical mean values, using one or more standardization neural network layers, to generate a respective adaptive mean value for each channel of the first layer output (404). For example, the system can generate a vector of adaptive mean values μₛₜₐₙ as:

$${μ}_{stan} = {f}_{dec} ( ReLU ( {f}_{enc} ( μ ) ) ) \qquad ( 5 )$$

where μ is a vector of statistical mean values (e.g., where each component μ_{c} of μ generated in accordance with equation (3)), f_{enc}(⋅) is a neural network layer (e.g., a fully-connected layer) that generates a lower-dimensional projected representation of μ, ReLU is a rectified linear unit activation function, and f_{dec} is a neural network layer (e.g., a fully-connected layer) that generates the vector of adaptive mean values μₛₜₐₙ.

Optionally, the system updates the adaptive mean values using the statistical mean values (406). For example, the system can generate updated adaptive mean values as:

$${μ}_{stan} ← {λ}_{u} \cdot {μ}_{stan} + ( 1 - {λ}_{μ} ) \cdot μ \qquad ( 6 )$$

where μₛₜₐₙ are the adaptive mean values, u are the statistical mean values, and λ_{μ} is a weighting factor. Optionally, the weighting factor λ_{μ} can be a learned weighting factor, e.g., that is iteratively updated during training. Updating the adaptive mean values using the statistical mean values can stabilize training. For instance, during the early stages of training, the adaptive mean values may be unstable, and the weighting factor can learn to compensate by favoring the statistical mean values. As training progresses and the adaptive mean values stabilize and become more effective than the statistical mean values, the weighting factor can learn to compensate by favoring the adaptive mean values.

The system jointly processes the set of statistical standard deviation values, using one or more standardization neural network layers, to generate a respective adaptive standard deviation value for each channel of the first layer output (408). For example, the system can generate a vector of adaptive standard deviation values σₛₜₐₙ as:

$${σ}_{stan} = {g}_{dec} ( ReLU ( {g}_{enc} ( σ ) ) ) \qquad ( 7 )$$

where σ is a vector of statistical standard deviation values (e.g., where each component σ_{c} of σ is generated in accordance with equation (4)), g_{enc}(⋅) is a neural network layer (e.g., a fully-connected layer) that generates a lower-dimensional projected representation of σ, ReLU is a rectified linear unit activation function, and g_{dec} is a neural network layer (e.g., a fully-connected layer) that generates the vector of adaptive standard deviation values σₛₜₐₙ.

Optionally, the system updates the adaptive standard deviation values using the statistical standard deviation values (410). For example, the system can generated updated adaptive mean values as:

$${σ}_{stan} ← {λ}_{σ} {σ}_{stan} + ( 1 - {λ}_{σ} ) σ \qquad ( 8 )$$

where σₛₜₐₙ are the adaptive mean values, σ are the statistical mean values, and λ_{σ} is a weighting factor. Optionally, the weighting factor λ_{σ} can be a learned weighting factor, e.g., that is iteratively updated during training. Updating the adaptive standard deviation values using the statistical standard deviation values can stabilize training. For instance, during the early stages of training, the adaptive standard deviation values may be unstable, and the weighting factor can learn to compensate by favoring the statistical standard deviation values. As training progresses and the adaptive standard deviation values stabilize and become more effective than the statistical standard deviation values, the weighting factor can learn to compensate by favoring the adaptive standard deviation values.

FIG. 5 is a flow diagram of an example process 500 for processing data derived from the first layer output using rescaling neural network layers of a rescaling block to generate adaptive rescaling values. For convenience, the process 500 will be described as being performed by a system of one or more computers located in one or more locations. For example, a neural network system, e.g., the neural network system 100 of FIG. 1, appropriately programmed in accordance with this specification, can perform the process 500.

The system generates, for each channel of the first layer output: (i) a statistical mean value defining a statistical mean of the components of the first layer output in the channel, and (ii) a statistical standard deviation value defining a statistical standard deviation of the components of the first layer output in the channel (502). An example technique for generating statistical mean values and statistical standard deviation values is described above with reference to step 402 of the process 400. If the system has previously generated statistical mean values and statistical standard deviation values for the channels of the first layer output, e.g., as part of generating adaptive standardization values, then the system can reuse the previously generated statistical mean values and statistical standard deviation values rather than re-computing them.

The system jointly processes the set of statistical mean values, using one or more rescaling neural network layers, to generate a respective additive rescaling value for each channel of the first layer output (504). For example, the system can generate a vector of adaptive rescaling values β as:

$$β = tanh ( {ψ}_{dec} ( ReLU ( {ψ}_{enc} ( μ ) ) ) ) \qquad ( 9 )$$

where μ is a vector of statistical mean values (e.g., where each component μ_{c} of μ generated in accordance with equation (3)), ψ_{enc}(⋅) is a neural network layer (e.g., a fully-connected layer) that generates a lower-dimensional projected representation of μ, tanh is an arctangent activation function, ReLU is a rectified linear unit activation function, and ψ_{dec} is a neural network layer (e.g., a fully-connected layer) that generates the vector of additive rescaling values β.

Optionally, the system updates the additive rescaling values using a learned bias term (506). For example, the system can generate updated additive rescaling values as:

$$β ← β + {β}_{bias} \qquad ( 10 )$$

where @ are the additive rescaling values and β_{bias} is the learned bias term. The learned bias term includes a set of trainable parameters that are jointly trained with the other parameters of the neural network during training. At the start of training, the learned bias term β_{bias} can be initialized, e.g., to a vector of zeros.

The system jointly processes the set of statistical standard deviation values, using one or more standardization neural network layers, to generate a respective multiplicative rescaling value for each channel of the first layer output (508). For example, the system can generate a vector of multiplicative rescaling values γ as:

$$γ = sigmoid ( {ϕ}_{dec} ( ReLU ( {ϕ}_{enc} ( σ ) ) ) ) \qquad ( 11 )$$

where σ is a vector of statistical standard deviation values (e.g., where each component σ_{c} of σ is generated in accordance with equation (4)), ϕ_{enc}(⋅) is a neural network layer (e.g., a fully-connected layer) that generates a lower-dimensional projected representation of σ, ReLU is a rectified linear unit activation function, g_{dec} is a neural network layer (e.g., a fully-connected layer) that generates the vector of multiplicative rescaling values γ, and sigmoid is a sigmoid activation function.

Optionally, the system updates the multiplicative rescaling values using a learned bias term (510). For example, the system can generate updated multiplicative rescaling values as:

$$γ ← γ + {γ}_{bias} \qquad ( 12 )$$

where γ are the multiplicative rescaling values and γ_{bias} is the learned bias term. At the start of training, the learned bias term γ_{bias} can be initialized, e.g., to a vector of ones (or some other default positive value).

This specification uses the term “configured” in connection with systems and computer program components. For a system of one or more computers to be configured to perform particular operations or actions means that the system has installed on its software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus, the method comprising:
obtaining a network input;
processing the network input using a neural network to generate a network output, wherein the neural network includes a normalization block that is between a first neural network layer and a second neural network layer in the neural network, wherein the normalization block comprises one or more standardization neural network layers, wherein processing the network input using the neural network comprises:
receiving a first layer output from the first neural network layer;
processing data derived from the first layer output using the standardization neural network layers of the normalization block to generate one or more adaptive standardization values;
standardizing the first layer output using the adaptive standardization values to generate a standardized first layer output;
generating a normalization block output from the standardized first layer output; and
providing the normalization block output as an input to the second neural network layer.

2. The method of claim 1, wherein the first layer output comprises a plurality of components that are indexed by a plurality of channels, wherein the adaptive standardization values comprise a respective adaptive mean value for each channel, and wherein generating the adaptive mean values comprises:
computing, for each of the channels, a statistical mean value defining a statistical mean of the components of the first layer output in the channel; and
processing the statistical mean values using one or more of the standardization neural network layers to generate the adaptive mean values.

3. The method of claim 2, wherein processing the statistical mean values using one or more of the standardization neural network layers to generate the adaptive mean values comprises:
processing the statistical mean values using a first standardization neural network layer to generate a lower-dimensional projected representation of the statistical mean values;
processing the projected representation of the statistical mean values using an activation function; and
processing a result of applying the activation function to the projected representation of the statistical mean values using a second standardization neural network layer to generate the adaptive mean values.

4. The method of claim 2, further comprising:
updating the adaptive mean value for each channel to be a weighted average of: (i) the adaptive mean value for the channel, and (ii) the statistical mean value for the channel.

5. The method of claim 4, wherein for each channel, the weighted average of: (i) the adaptive mean value for the channel, and (ii) the statistical mean value for the channel, is computed using a learned weighting factor.

6. The method of claim 2, wherein the adaptive standardization values further comprise a respective adaptive standard deviation value for each channel, and wherein generating the adaptive standard deviation values comprises:
computing, for each of the channels, a respective statistical standard deviation value defining a statistical standard deviation of the components of the first layer output in the channel; and
processing the statistical standard deviation values using one or more of the standardization neural network layers to generate the adaptive standard deviation values.

7. The method of claim 6, wherein processing the statistical standard deviation values using one or more of the standardization neural network layers to generate the adaptive standard deviation values comprises:
processing the statistical standard deviation values using a first standardization neural network layer to generate a lower-dimensional projected representation of the statistical standard deviation values;
processing the projected representation of the statistical standard deviation values using an activation function; and
processing a result of applying the activation function to the projected representation of the statistical standard deviation values using a second standardization neural network layer to generate the adaptive standard deviation values.

8. The method of claim 6, further comprising:
updating the adaptive standard deviation value for each channel to be a weighted average of: (i) the adaptive standard deviation value for the channel, and (ii) the statistical standard deviation value for the channel.

9. The method of claim 8, further comprising:
updating the adaptive standard deviation value for each channel to be a sum of: (i) the adaptive standard deviation value for the channel, and (ii) a predefined e value.

10. The method of claim 1, wherein the adaptive standardization values comprise a respective adaptive mean value and a respective adaptive standard deviation value for each of the channels in the first layer output, and wherein standardizing the first layer output using the adaptive standardization values comprises:
standardizing each component of the first layer output using the adaptive mean value and the adaptive standard deviation value for the channel corresponding to the component.

11. The method of claim 10, wherein standardizing each component of the first layer output using the adaptive mean value and the adaptive standard deviation value for the channel corresponding to the component comprises, for each component:
subtracting, from the component, the adaptive mean value for the channel corresponding to the component; and
dividing a result of the subtraction by the adaptive standard deviation value for the channel corresponding to the component.

12. The method of claim 1, wherein generating a normalization block output from the standardized first layer output comprises:
processing data derived from the first layer output using one or more rescaling neural network layers of the normalization block to generate one or more adaptive rescaling values; and
generating the normalization block output by rescaling the standardized first layer output using the one or more adaptive rescaling values.

13. The method of claim 12, wherein the first layer output comprises a plurality of components that are indexed by a plurality of channels, wherein the adaptive rescaling values comprise a respective additive rescaling value and a respective multiplicative rescaling value for each channel, and wherein generating the normalization block output comprises, for each component of the standardized first layer output:
multiplying the component by the multiplicative rescaling value for the channel corresponding to the component; and
adding the additive rescaling value for the channel corresponding to the component to a result of the multiplication.

14. The method of claim 13, wherein generating the additive rescaling values comprises:
computing, for each of the channels, a respective statistical mean value defining a statistical mean of the components of the first layer output in the channel; and
processing the statistical mean values using one or more of the rescaling neural network layers to generate the additive rescaling values.

15. The method of claim 14, further comprising:
updating each additive rescaling value by adding a learned bias term to the additive rescaling value.

16. The method of claim 13, wherein generating the multiplicative rescaling values comprises:
computing, for each of the channels, a respective statistical standard deviation value defining a statistical standard deviation of the components of the first layer output in the channel; and
processing the statistical standard deviation values using one or more of the rescaling neural network layers to generate the multiplicative rescaling values.

17. The method of claim 16, further comprising:
updating each multiplicative rescaling value by adding a learned bias term to the multiplicative rescaling value.

18. The method of claim 1, wherein the neural network is trained using adversarial domain augmentation.

19. A system comprising:
one or more computers; and
one or more storage devices communicatively coupled to the one or more computers, wherein the one or more storage devices store instructions that, when executed by the one or more computers, cause the one or more computers to perform operations comprising:
obtaining a network input;
processing the network input using a neural network to generate a network output, wherein the neural network includes a normalization block that is between a first neural network layer and a second neural network layer in the neural network, wherein the normalization block comprises one or more standardization neural network layers, wherein processing the network input using the neural network comprises:
receiving a first layer output from the first neural network layer;
processing data derived from the first layer output using the standardization neural network layers of the normalization block to generate one or more adaptive standardization values;
standardizing the first layer output using the adaptive standardization values to generate a standardized first layer output;
generating a normalization block output from the standardized first layer output; and
providing the normalization block output as an input to the second neural network layer.

20. One or more non-transitory computer storage media storing instructions that when executed by one or more computers cause the one or more computers to perform operations comprising:
obtaining a network input;
processing the network input using a neural network to generate a network output, wherein the neural network includes a normalization block that is between a first neural network layer and a second neural network layer in the neural network, wherein the normalization block comprises one or more standardization neural network layers, wherein processing the network input using the neural network comprises:
receiving a first layer output from the first neural network layer;
processing data derived from the first layer output using the standardization neural network layers of the normalization block to generate one or more adaptive standardization values;
standardizing the first layer output using the adaptive standardization values to generate a standardized first layer output;
generating a normalization block output from the standardized first layer output; and
providing the normalization block output as an input to the second neural network layer.
